(19) United States
(12) Patent Application Publication
(10) Pub. No.: US 2017/0217237 A1
(43) Pub. Date: Aug. 3, 2017

(54) BASE BODY FOR RECEIVING A PRINT IMAGE STRUCTURE

(71) Applicant: Martin KRÜMPELMANN, Lengerich (DE)

(72) Inventor: Martin KRÜMPELMANN, Lengerich (DE)

(21) Appl. No.: 15/489,619

(22) Filed: Apr. 17, 2017

Related U.S. Application Data
(63) Continuation of application No. PCT/EP2015/073766, filed on Oct. 14, 2015.

(30) Foreign Application Priority Data
Oct. 16, 2014 (LU) 92573

(51) Int. Cl. B41N 1/22; B41C 1/18; B32B 27/06; B32B 1/08; B32B 5/18; B32B 7/12; B41C 1/00; B33Y 70/00

(52) U.S. Cl. CPC B41N 1/22; B41C 1/003; B41C 1/182; B33Y 70/00; B32B 1/08; B32B 5/18; B32B 7/12; B32B 27/065; B32B 2250/03; B32B 2250/24; B32B 2266/0214; B32B 2266/14; B32B 2307/51; B32B 2262/101; B32B 2262/106; B32B 2597/00

(57) ABSTRACT

The invention relates to a base body (10) for receiving a print image structure (20), in particular for flexographic printing, comprising a sleeve (10.1), an elastic layer (10.2) applied onto the sleeve (10.1) for holding an outer carrier layer (10.3), and the outer carrier layer (103), the carrier layer (10.3) being designed in such a mariner that the print image structure (20) can be applied.

### CROSS-REFERENCE TO RELATED APPLICATIONS

This application is a continuation of International Application No. PCT/EP2015/073766, filed Oct. 14, 2015, which claims priority to Luxembourg Patent Application No. 92573, filed Oct. 16, 2014, both of which are incorporated by reference herein in their entireties.

### BACKGROUND

1) Technical Field

The invention relates to a base body for receiving a print image structure, according to claim 1. Further the invention relates to a method for producing a base body, according to claim 13.

2) Description of the Related Art

In the printing industry different methods for printing are known to transfer motives as a print image to an imprint material, for example paper or film. Thereby so called flexoprinting is a possibility for printing with which the elevated positions of the printing block are image supporting. As a printing form for example clichés are used, which comprise the print image and which are able to transfer the print image via a print image structure. Thereby normally the clichés are agglutinated to base bodies like printing cylinders, sleeves or Sleeves. The clichés for example comprise a carrier film or layer, which is applied to a print image layer for example photo polymer. The print image structure can thereby for example be generated by the contribution of a relief for example by exposure on a photo polymer or on the print image layer (the photo polymer thereby configures the print image structure). The resulting print forms (configured from carrier layer and print image structure) are subsequently agglutinated to the sleeve or to the base body, particularly with adhesive tapes.

Thereby it has turned out as a disadvantage that for known base bodies an extensive production and application of the print form to the base body is necessary. An adjustment of the print image in the printing process is thereby very extensive, since the generation of the print image structure and the subsequent arrangement of the print image structure to the sleeve or the base body are separate working processes. Normally, known base bodies enable only a restricted and extensive adjustment of the print image in the printing process.

It is therefore the object of the present invention, to at least partially avoid the previously described disadvantages. Particularly, a base body for the acceptance of a print image structure and configuration of a printing form is proposed, which is suitable for a faster, cheaper and more flexible use in the printing process, particularly for the flexoprint.

### SUMMARY OF THE INVENTION

The previous object is solved by a base body with the features of claim 1 and a method with the features of claim 13. Further features and details of the invention result from the respective dependent claims, the description and the drawings. Thereby features and details which are described in connection with the base body according to the invention naturally also apply in connection with the method according to the invention and vice versa, such that according to the disclosure of the single aspects of the invention it can always be reciprocally related to.

The base body according to the invention serves for the acceptance of a print image structure, particularly for a flexoprint. The base body comprises a sleeve, particularly a Sleeve, which is preferably suitable for being pushed to a mandrel. On the sleeve an elastic layer is applied which serves for retaining the outer carrier layer. Further, the base body comprises an outer carrier layer, wherein the carrier layer is configured such that the print image structure is applicable. Hereby the advantage is achieved that the base body already comprises a carrier layer for the acceptance of the prim image structure, particularly a print image layer with a print image structure. Hereby it is particularly possible that a separate production of a printing form (or a clich) can be waived, which comprises a carrier layer and a print image layer. By applying only the print image structure the print form can for example be configured directly at or on the base body in the printing process. This is achieved by the fact that the carrier layer is already provided at the base body and thus configures the print form together with the applicable print image structure (for example as a print image layer). The generation of the print image structure and the arrangement at the base body can, if necessary, occur due to the configuration of the base body according to the invention as a single process step. This provides significant advantages, particularly in comparison with a separate production of a print form and a subsequent application on the base body, since the print image or the print image structure can be applied or adjusted flexibly, fast and individually directly to the carrier layer of the base body. The base body can further subsequently immediately be used for a further printing process.

It is further possible that the print form at the base body is directly produced at a printing machine, wherein the printing process is further accelerated and costs can be reduced. This is possible among others, since the normal priming process remains widely unchanged and therefore no significant adjustments for the use of the base body according to the invention are necessary. It is for example sufficient for the production of the printing form to use a printing form machine which directly applies the print image structure to the base body. Further, for example an application of the print image structure can occur and/or an existing print image structure or print image layer can be adjusted, such that for example material is altered, applied and/or removed by the print image machine. The print image machine can further for example be suitable for the performance of additive production methods (like 3D printing, electron beam melting, laser melting, stereolithograpby, selective laser melting, sintering, laser sintering) and/or subtractive production methods (like removing, laser removing, thermal separation, electron beam separation) and/or engraving (laser engraving) and/or a forming process.

Further, the carrier layer can preferably be configured in a way that it is suitable as a ground or underlay for the performance of additive production methods, particularly 3D printing, subtractive production methods, particularly laser removal, engraving, particularly laser engraving, and/or deformation and for the application or acceptance of the hereby produced print image structure. Therefore the carrier layer for example comprises a roughened surface and a heat resistance, melting point and/or stability adjusted to the production process, Hereby the resistance of the carrier layer is increased in order to withstand the conditions during the application of the print image structure, like an increased temperature.

It is further an advantage, when within the scope of the invention it is provided that the carrier layer is configured in a way that the print image structure is applicable by a production method, particularly by a 3D printing method with a priming form machine. The printing machine can thereby for example be configured as a 3D printer and/or a digital fabricator. Such devices can for example generate material, three-dimensional objects on the basis of digital CAD (Computer Aided Design) data. The data therefore provide templates for the print image structure, which for example are existent in STL (Surface Tessellation Language) format or in another data format. The printing machine can thereby for example produce the subject or the print image structure by an additive and/or subtractive production method, for example by a layerwise composition of the print image structure. Hereby a cost-efficient and flexible production of the print image structure is possible.

Further it is possible that the print forming machine comprises a laser and/or a (UV-) light source for example for laser melting, layerwise hardening of a construction material and/or a laser cutting, wherein the carrier layer is suitable to serve as a ground for the production process (for example melting process) of the print forming machine. In order to resist the high temperatures during the production process, the carrier layer comprises for example a heat resistance up to 50° C., 100° C., 200° C. and/or up to 300° C. The production method is thereby particularly an additive production method, wherein successive material (the construction material) is added and deposited, wherein by this manner of production and for example the small loss of material the flexibility can be increased and the costs can be reduced.

It is further possible, that the carrier layer configures a stiff layer from a plastic, particularly polyester, polyurethane and/or PET (polyethylene terephthalate). Thereby with the use of polyester a good form stability for the application of the print image structure is an advantage. Polyurethane possesses a very high tensile strength, wherein PET comprises a good form stability and breaking. strength even with high temperatures. The melting point of PET, which is at 250 degrees Celsius up to 260 degrees Celsius, is further suitable for a 3D printing method or similar production methods with high temperatures. Further preferably the carrier layer can be configured from a plastic with a melting point over 300 degrees Celsius. Therewith a damage of the carrier layer during the application of the print image structure is prevented.

The carrier layer thereby comprises a higher degree of hardness than the elastic layer and therefore possesses a lower elasticity and for example a higher strength (for example pressure, compression and/or bending strength). Likewise it is possible that the carrier layer comprises a coating, wherein the coating comprises for example a higher strength and/or hardness than the inner material of the carrier layer. Further, the carrier layer can for example at least on one side comprise a flexible, elastic and/or adherent outer layer. Likewise the outer layer, on which the print image structure is configured, particularly can be configured in a way that a simple dissolution (peeling) of the applied print image structure is possible. This is enabled by an adhesion failure during force influence conditioned by the configuration of the carrier layer. Therewith a reliable application of the print image structure is possible. Further, the carrier layer can be particularly suitable to configure an adhesion of the print image structure, in case the carrier layer is configured from a plastic with a high surface energy.

Preferably, within the scope of the invention it can be provided that the elastic layer is configured from a foam material, particularly polyurethane, polypropylene, polyethylene, polystyrene, PET and/or biopolymer. Further it is possible that the elastic layer is configured at least partially from polymer, from rubber and/or plastic tape. Here likewise advantages result, like they are previously described for the carrier layer, Particularly with the use of plastics like PET, polyurethane or such like a damage of the elastic layer can be avoided, when the plastics comprise a high tensile strength and form stability. PET comprises further a high melting point, wherein a damage with high temperatures is avoided, Particularly elastomers, for example from polyurethane, are suitable due to the elastic properties and high tensile strength for the configuration of the elastic layer. Further polypropylene possesses a particularly high stiffness, hardness and stability and is particularly suitable for the production of foam materials for the elastic layer. Likewise polyethylene, polystyrene and biopolymers are very good for the production of a foam material and further possess a low water intake, a good temperature resistance and a high toughness.

Further, the elastic layer can be configured compressible, wherein it is particularly suitable for a halftone printing. As an elastic and compressible layer the elastic layer of the base body according to the invention deforms, such that the so called dot gain and therewith related loss of quality of the print can be reduced. The dot gain thereby leads to undesired effects during the printing process, since the priming points are elastically widened. For the reduction of the dot gain it can for example be provided that the elastic layer alternatively comprises a smaller compressibility than the carrier layer, thereby the outer carrier layer comprises a corresponding higher elasticity than the elastic layer.

In a further possibility within the scope of the invention it can be intended that the sleeve is configured from glass fiber reinforced plastic or carbon fiber reinforced plastic. Hereby the sleeve comprises particular advantages, like a high resistibility and strength. Further it is possible that the sleeve is configured from epoxy resins, polyester resins (for example reinforced with glass fiber fabric), from elastomer composite material or other polymers. Thus, the elastic probabilities of the sleeve can be well adjusted. Further, the sleeve can for example be coated with elastomer composite material like rubber or polyurethane. The wall thickness of the sleeve can thereby be for example 0.15 mm to 3 mm and particularly 0.5 mm to 2 mm. Since the sleeve has to be applied to the mandrel within the scope of the printing process, wherein the sleeve is impinged for example with air pressure for pushing on and removing, it can be suitable for a broadening by air pressure and comprise a sufficient flexibility. For example the sleeve can be suitable to be broadened with an air pressure of for example 6 to 12 bar. For pushing on it is further an advantage, when the sleeve comprises a flexible layer on its inner layer. Hereby a simple mounting to the mandrel is enabled.

Further it can be intended within the scope of the present invention that the elastic layer is configured as a one-side or both-side adhesive tape and/or a one-side or both-side adhesive material. For retaining the carrier layer and/or arrangement at the sleeve the elastic layer can preferably be configured as adhesive tape and/or adhesive material. Alternatively, the elastic layer can comprise further retaining or fastening means, like for example magnetized bodies and particularly ferromagnetic bodies. Therewith a fastening can occur by magnetisation. In order to achieve a hard adhesion, the elastic layer can comprise for example a thickness of mainly 0.1 mm and in order to enable a soft adhesion the elastic layer can for example comprise a thickness of mainly 0.2 mm to 1. mm. The described manner of the adhesion (hard or soft) thereby determines in a significant manner the existence of pressure peaks during the printing process and influences the printing quality. The adhesion material can for example be configured on basis of natural rubber, on basis of polyacrylics, on basis of block copolymer and/or on basis of acrylic. Therewith, the adhesive material serves for a good and secure adhesion, wherein the adhesive material can be configured suitable for the adhesion on PET and, if necessary, removable. Further it is possible that the adhesive material, the adhesive tape and/or the elastic layer are self-adhesive, compressible and/or permanently adhesive. The surface of the elastic layer comprises for example a shrinkage-free and if necessary hardened, rigid layer, in order to stabilize the foam material.

It can be a further advantage within the scope of the present invention, that for the attachment of the elastic layer a first adhesive layer and/or for the attachment of the carrier layer a second adhesive layer is provided, wherein particularly the first and second adhesive layer are configured from both-side adhesive tape. It is therewith possible that for example only a first adhesive layer and/or only a second adhesive layer is provided, wherein the adhesive layers can be configured with different properties (for example a different thickness and/or different material). Further, the adhesive layers can comprise features and details which are described previously in relation to the elastic layer and the adhesive layer. Hereby the advantage results that a secure fixation of the elastic layer and/or carrier layer on the base body is enabled.

Preferably, within the scope of the present invention it can be intended that the base body comprises an information device with a communication unit for data transmission, particularly with a printing machine, For the data transmission thereby particularly a radio connection can serve, for example with the printing machine and/or with the printing form machine. Hereby a contactless data transmission is enabled, wherein the data particularly the print image can comprise an identification code and/or method parameter. The method parameters thereby are for example method parameters for the printing process, like for example a maximum contact pressure, properties of the base body and/or the printing form and/or other parameters. It is for example possible, that the carrier layer not completely comprises a print image structure, but partially remains free. The remaining free areas or positions of the print image structure on the carrier layer can for example be saved as parameter and can be provided to the printing machine. By the described measures the base body can reliably be integrated in the automatization process.

Preferably, it can be provided with a base body according to the invention, that the communication unit is suitable for a contactless data transfer according to a communication standard like the RFID (Radio Frequency Identification), NFC (Near Field Communication) and/or Bluetooth standard. Therewith a secure and reliable data transmission for example to the printing machine and/or to the printing form machine is enabled. The communication unit can thereby for example comprise a transponder for the contactless energy transfer, wherein the communication unit (particularly only is operated by the generation of a tension or the induction by an (electro-) magnetic field. Herefore the communication unit comprises for example an induction antenna or induction coil. The coil can thereby for example comprise a ferromagnetic core in order to further increase the efficiency of the energy and/or data transfer. Such a coil can for example be used for the transfer of radio signals, for example for a data transfer according to the NFC and/or Bluetooth standard. Alternatively it is for example possible that the communication unit is configured as HF- (High Frequency) or LF- (Low Frequency) interface. Further it can be intended that a first communication unit for the communication with a first device (for example the printing machine) and a second In communication unit for the communication with a second device (for example the printing form machine) is assembled in the printing body. The communication units can thereby be operated according to different communication standards. In this manner a secure and reliable transfer of data with different machines is possible.

Preferably, it can be intended within the scope of the invention that the base body comprises a non-volatile: memory unit, wherein the non-volatile memory unit comprises an identification code, particularly for the distinct identification of the base body at the printing machine. Thereby the memory unit can for example be a data carrier like a hard disk, a flash memory, a SD memory (Secure Digital Memory Card), a SSD memory (Solid-state Drive) and/or an EPROM (Erasable Programmable Read-Only Memory). In this manner a durable saving, of the identification code independent from the energy supply is enabled. Further the memory unit can comprise further data and method parameter, like for example the print image. The print image can for example be saved in a STL-format (Surface Tessellation Language) and/or in another CAD format of the memory unit. Likewise the data can be at least partially encrypted. Therewith the advantage is achieved that a communication with different printing form machines which likewise support the format is possible.

It is further an advantage, when is provided within the scope of the invention it that the base body comprises a non-volatile memory unit, wherein the non-volatile memory unit comprises digital data with information about the print image, particularly with production information for a production method. The production information can thereby be information about the structure of the base body, about the used material for example for the elastic layer and./or the carrier layer and/or the thickness of the corresponding layers. In this manner an automatization of the production process of the printing form of the printing process can be further accelerated.

Further it is possible that the elastic layer has a thickness of 0.1 mm to 2 mm, particularly of 0.5 mm to 1 mm and/or the carrier layer has a thickness of 100 μm to 1000 μm, particularly mainly 300 μm. Likewise it can be provided that the base body comprises an extent of 250 mm to 1500 mm. By the described configuration of the base body preferable properties for the printing process, particularly the reduction of pressure peaks, is achieved. Further the described embodiment of the base body can filter disturbing oscillation frequencies of the base body or pressure cylinder which result from a rotation during the printing process and thus improve the printing quality and the life span. Therewith it is possible that the thickness of the layers of the base body, for example within the described areas for the thickness, the properties for the used printing machine and for example the printing cylinders (for example the extent) are adapted in order to achieve an optimal frequency filtration.

Likewise subject matter of the invention is a method for the production of a base body for the acceptance of a print image structure, particularly for the flexoprint, wherein an elastic layer for retaining an outer carrier layer is applied to a sleeve and the carrier layer is applied to the elastic layer, wherein the carrier layer is configured in a way that the print image structure can be applied. The sleeve can thereby for example be a Sleeve and for example be suitable for being pushed on a mandrel. Therewith the method according to the invention comprises the same advantages like they are described in detail in relation to the base body according to the invention. Further, the method according to the invention can serve for the production of a base body according to the invention.

Further a printing cylinder can be subject matter of the present invention which comprises the base body according to the invention. The printing cylinder according to the invention comprises the same advantages like they are described in detail for the method according to the invention or in relation to the base body according to the invention.

### BRIEF DESCRIPTION OF THE DRAWINGS

Further advantages, features and details of the invention result from the subsequent description, in which in relation to the drawings embodiments of the invention are described in detail. Thereby, the features described in the claims and in the description can be essential for the invention each single by themselves or in any combination, it is shown:

FIG. 1 is a schematic representation of a base body according to the invention in a perspective representation according to a first embodiment.

FIG. 2 is a schematic sectional view of a base body according to the invention according, to a first embodiment.

FIG. 3 is a further schematic sectional view of a base body according to the invention according to a further embodiment.

FIG. 4 is a schematic representation of an information device of a base body according to the invention.

FIG. 5 is a schematic representation for the visualisation of method steps of a method according to the invention and

FIG. 6 is a schematic representation of a base body according to the invention with an applied print image structure.

### DETAILED DESCRIPTION

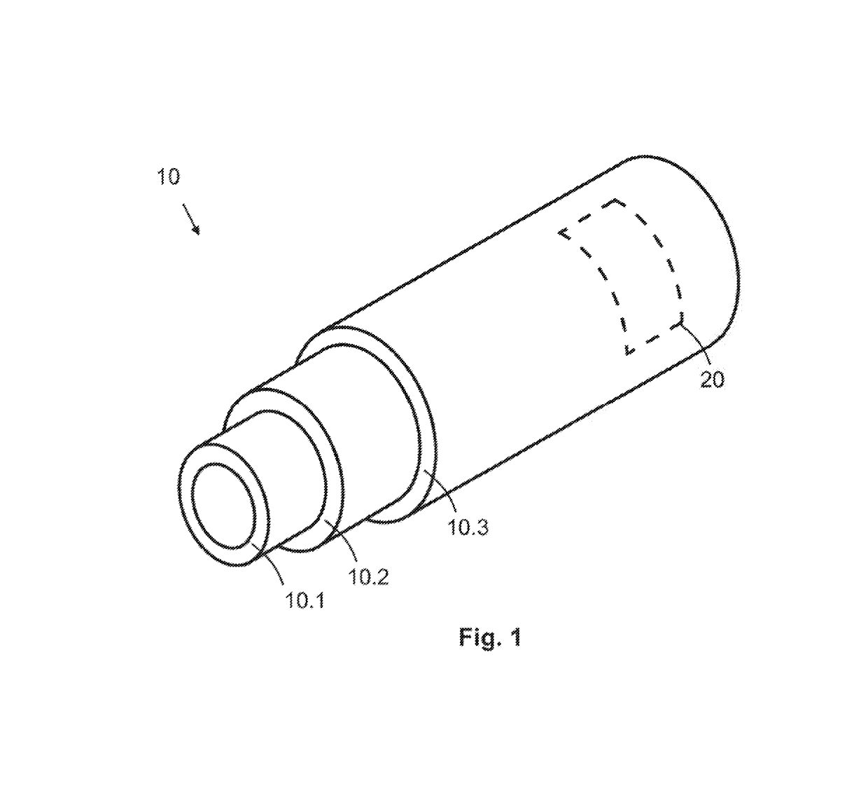

FIG. 1 shows a base body 10 according to the invention in a schematic, perspective view. In all figures the thickness of the layers of the base body 10 for the representation is only schematically visualized and therefore not true to scale. Only for the better representation further the different layers are shown with different lengths in FIG. 1. Preferably however all layers comprise mainly the same length, which is particularly adapted to the length of the sleeve 10.1. The elastic layer 10.2 is thereby for example applied directly to the sleeve 10.1. Thereby the elastic layer 10.2 can for example be applied on the sleeve 10.1 by adhesive tape and, for example, can be configured self-adhesive for the application of the sleeve 10.1. In case the elastic layer 10.2 is configured self-adhesive, it comprises a not shown adhesive material (adhering adhesive material) 10.4. Further the elastic layer 10.2 comprises an outer carrier layer 10.3 which can be radially further outside of the elastic layer 10.2 and/or can be the radially outermost layer. The carrier layer 10.3 is thereby suitable, such that a print image structure 20 can be applied to the carrier layer 10.3, particularly in a manner that it permanently and/or during the printing process remains on the carrier layer 10.3. The print image structure 20 is only schematically visualized by a dashed line. The shown base body 10 can further comprise for example at the inner side a flexible layer for example from a polymer (not shown), wherein the pushing on to the mandrel 42 is simplified.

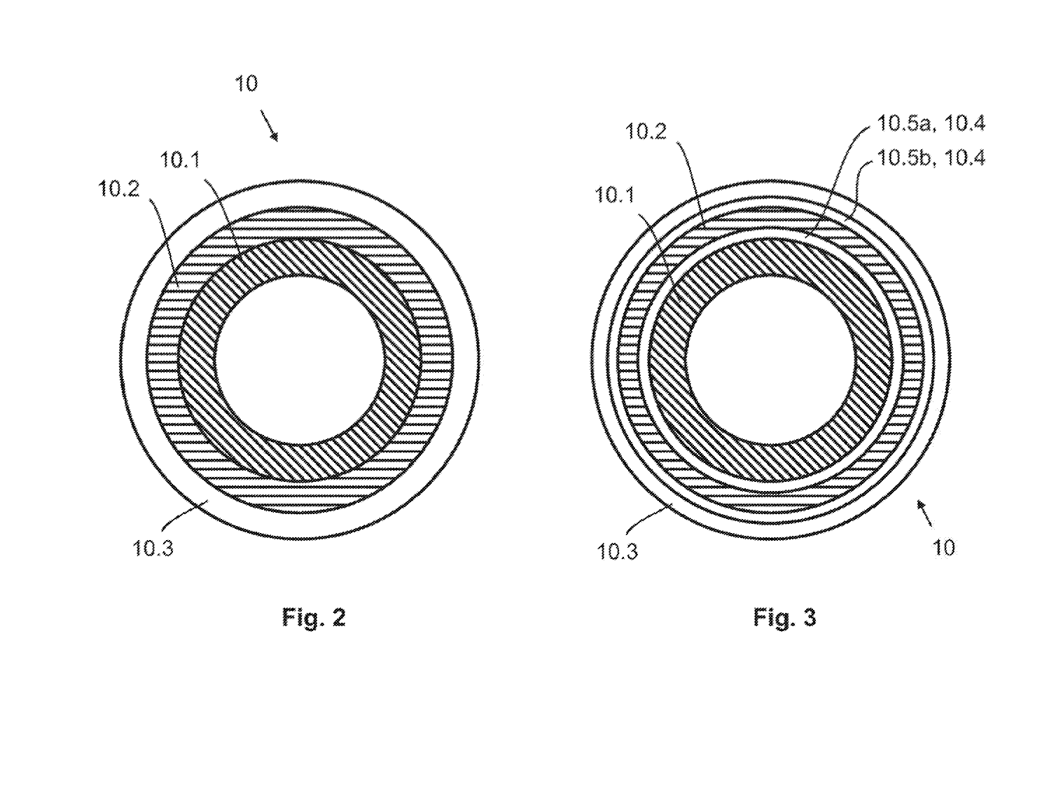

FIG. 2 shows a schematic sectional view of the base body 10 according to the invention, Like in FIG. 1 a sleeve 10.1, a thereon applied elastic layer 10.2 and a thereon applied carrier layer 10.3 are shown. A retaining of the carrier layer 10.3 is for example effected thereby that the elastic layer 10.2 comprises a not shown adhesive material 10.4 and therewith itself configures for example an adhesive tape being adhesive on both sides.

In FIG. 3 is shown a first adhesive layer 10.5a and a second adhesive layer 10.5b according to another embodiment. It is further possible that for example only the first adhesive layer 10.5a without the second adhesive layer 10.5b or only the second adhesive layer 10.5b without the first adhesive layer 10.5a is intended (not shown). Further, alternatively an adhesive material 10.4 can be assembled at the position of the first adhesive layer 10.5a and the second adhesive layer 10.5b, meaning between the sleeve 10.1 and the elastic layer 10.2 and between the elastic layer 10.2 and the carrier layer 10.3. The adhesive material 10.4 and also the first and second adhesive layers 10.5a. 10.5b thereby serve for a secure arrangement and application of the layers of the base body 10.

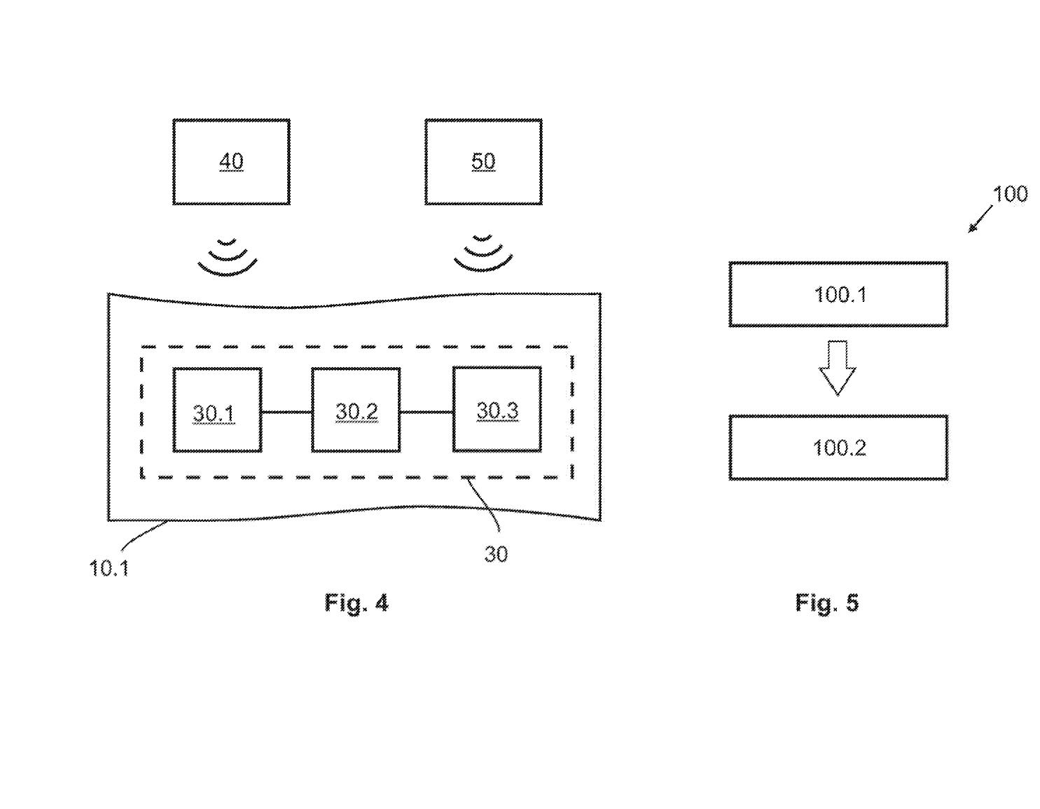

In FIG. 4 an arrangement of an information device 30 in a sleeve 10.1 of the base body 10 is shown schematically. Thereby the information device 30 comprises a communication unit 30.1 which for example comprises a RFID transponder in order to affect a contactless data exchange for example with a printing machine 40 or a printing form machine 50. Thereby the communication unit 30.1 can be electrically (electronically) connected with a non-volatile memory unit 30.2 and an evaluation unit 30.3. The evaluation unit 30.3 is preferably configured as a microprocessor, microcontroller and/or processor, which for example controls the data transfer and enables a reliable data evaluation of the received data. Further it is possible that the evaluation unit 30.3 and/or the information device 30 comprise an interface via which data for example from an external device, particularly a computer, can be transcribed into the non-volatile memory unit 30.2 (like for example a desired print image in CAD format). Likewise in this manner further method parameters for example for the printing process can be transcribed into the non-volatile memory unit 30.2 and for example during the printing process can be read out by the printing machine 40 and/or the printing form machine 50. Thus, for example a print image which the printing form machine 50 should generate as a print image structure 20 to the base body 10 can be saved as a specification in the non-volatile memory unit 31.2 and can be transferred contactless from the communication unit 30.1 to the printing form machine 50.

In FIG. 5 schematic method steps of a method 100 according, to the invention are visualized. In a first method step 100.1 an elastic layer 10.2 for retaining an outer carrier layer 10.3 on a sleeve 10.4 is applied. In a further method step 100.2 the carrier layer 10.3 is applied to the elastic layer 10.2. In this manner a base body 10 according to the invention is produced, wherein the carrier layer 10.3 is configured, such that the print image structure 20 is applied reliably in a way that it remains applied on the carrier layer 10.3 for a defined duration or permanently.

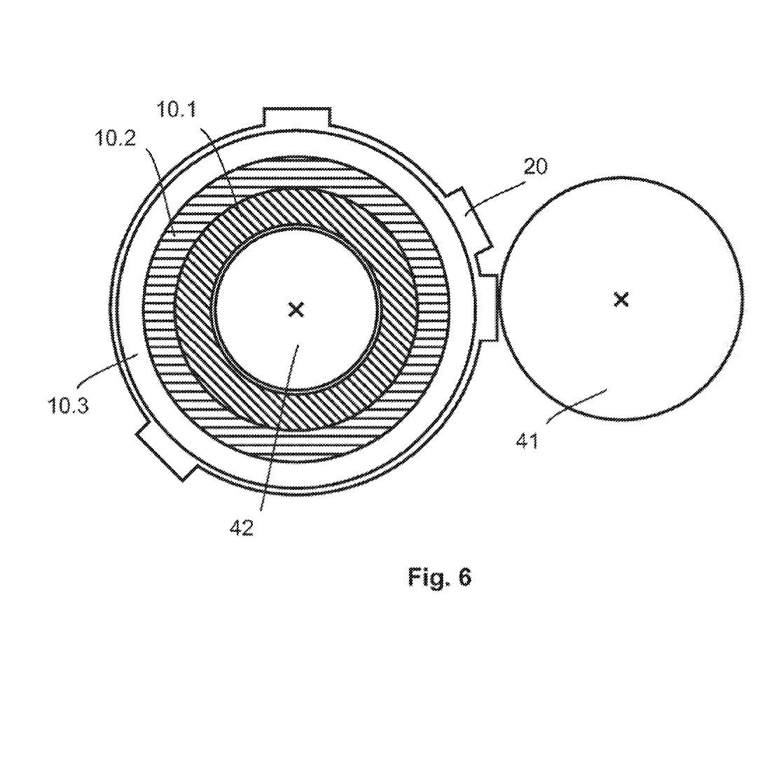

In FIG. 6 a sectional view of a base body 10 according to the invention is shown schematically. Hereby the print image structure 20 is already applied to the carrier layer 10.3. Thereby the use of a base body 10 according to the invention in a printing machine 40 is visualized during the printing process. Thereby the base body 10 is applied with a sleeve 10.1 of the elastic layer 10.2 and the carrier layer 10.3 at a mandrel 42 of the printing machine 40. Further, a counter pressure cylinder 41 of the printing machine 40 is shown, wherein the printing liability is generated. Between the counter pressure cylinder 41 and the print image structure 20 the printing material to which the print image should be transferred can be guided.

The previous description of the embodiments describes the present invention only within the scope of examples. Naturally, single features of the embodiment, as far as technically meaningful, can be freely combined with one another without leaving the scope of the present invention.

### REFERENCE LIST

1.0 Base body
10.1 Sleeve
10.2 Elastic layer
10.3 Carrier layer
10.4 Adhesive material
10.5a First adhesive layer
10.5b Second adhesive layer
20 Print image structure
30 Information device
30.1 Communication unit
30.2 Non-volatile memory unit
30.3 Evaluation unit
40 Printing machine
41 Counter pressure cylinder
42 Mandrel
50 Printing form machine
100 Method
100.1 First method step
100.2 Second method step

We claim:

1. A base body for receiving a print image structure, comprising
a sleeve,
an elastic layer applied on the sleeve for retaining an outer carrier layer, and
the outer carrier layer, wherein
the outer carrier layer is configured, such that the print image structure is applicable.

2. The base body according to claim
wherein
the carrier layer is configured, such that the print image structure is applicable by a production method.

3. The base body according to claim 1,
wherein
the carrier layer is configured as a hard layer from a plastic.

4. The base body according to claim 1,
wherein
the elastic layer comprises a foam material.

5. The base body according to claim 1,
wherein
the sleeve is configured from glass fiber-reinforced plastic or carbon r-reinforced plastic.

6. The base body according to claim
wherein
the elastic layer at least is configured as a one-side or both-side adhesive: tape comprises a one-side or both-side adhesive material.

7. The base body according to claim 1,
wherein
at least for the attachment of the elastic layer a first adhesive layer or for the attachment of the carrier layer a second adhesive layer is provided.

8. The base body according to claim 1,
wherein
the base body comprises an information device with a communication unit for data transfer.

9. The base body according to claim 8,
wherein
the communication unit is suitable for a contactless data transfer according, to at least a RFID, NFC or Bluetooth standard.

10. The base body according to clan
wherein
the base body comprises a non-volatile memory unit, wherein the non-volatile memory unit comprises an identification code.

11. The base body according to claim 1.
wherein
the base body comprises a non-volatile memory unit, wherein the non-volatile memory unit comprises digital data with information about the print image.

12. The base body according to claim
wherein
the elastic layer has a thickness of 0,1 mm to 2 mm or the carrier layer has a thickness of 100 μm to 1000 μm.

13. A method for the production of a base body for receiving a print image structure, wherein
the elastic layer is applied to a sleeve, and
an outer carrier layer is applied to the elastic layer, wherein
the outer carrier layer is configured such that the print image structure is applicable.

14. The method according to claim 13,
wherein
a base body for receiving a print image structure, comprising the sleeve,
the elastic layer applied on the sleeve for retaining the outer carrier layer, and the outer carrier layer wherein
the outer carrier layer is configured, such that the print image structure is applicable, is used.

15. The method according to claim 13,
wherein
the outer carrier layer is configured such that the print image structure is applicable by a 3D-printing method.

16. The base body according to claim 11,
wherein
the non-volatile memory unit comprises digital data with information about the print image with production information at least for the production method or for a printing form machine.

17. The base body according to claim 8,
wherein
the base body comprises an information device with a communication unit for data transfer for data exchange with at least a printing machine or a printing form machine.
